(19) United States
(12) Patent Application Publication
(10) Pub. No.: US 2023/0175155 A1
(43) Pub. Date: Jun. 8, 2023

(54) WATER SUPPLY OXYGENATION SYSTEMS AND METHODS

(71) Applicant: Ohmium International, Inc., Incline Village, NV (US)

(72) Inventors: Arne Ballantine, Incline Village, NV (US); Parke Ballantine, Incline Village, NV (US)

(21) Appl. No.: 18/076,343

(22) Filed: Dec. 6, 2022

Related U.S. Application Data
(60) Provisional application No. 63/286,830, filed on Dec. 7, 2021.

(51) Int. Cl. C25B 15/08; C25B 1/04; C02F 1/72

(52) U.S. Cl. CPC C25B 15/08; C02F 1/727; C25B 1/04; C02F 2103/20

(57) ABSTRACT

The present disclosure provides systems and methods for increasing the oxygen concentration of a water supply. The systems generally include a water supply and an electrolyzer module that generates oxygen to be added to the water supply. The methods generally include generating oxygen using an electrolyzer module and adding the generated oxygen to a water supply.

### CROSS REFERENCE TO RELATED APPLICATIONS

This application claims priority to U.S. Provisional Application No. 63/286,830 entitled “WATER SUPPLY WITH SOLAR DRIVEN OXYGENATION FOR SANITATION AND ENHANCED HEALTH” filed Dec. 7, 2021, the contents of which are incorporated by reference herein in their entirety.

### FIELD OF THE DISCLOSURE

The present disclosure is related to systems and methods for increasing the concentration of oxygen in a water supply. Therefore, the application relates to the fields of chemistry and chemical engineering.

### BACKGROUND

Sanitization of water supplies is important to provide potable drinking water and for other uses, such as physical exercise and recovery therapies. Generally, water is sanitized by the addition of salts and or other chemicals that may be harmful if consumed or that may be irritating to the skin. Previous work has shown that increasing the concentration of oxygen in water disrupts the growth of bacteria. What is needed is a method for adding oxygen to a water supply to improve water sanitization.

### SUMMARY

Provided herein are systems for increasing the oxygen concentration of a water supply. The systems generally comprise an electrolyzer module operable to produce oxygen and a water supply fluidly connected to the electrolyzer module such that the water supply is operable to receive oxygen produced by the electrolyzer module. The oxygen concentration of the water supply is from about 1 mg/L to about 20 mg/L. In some embodiments, the water supply comprises a pipeline. In some additional embodiments, the electrolyzer module is fluidly connected to the water supply at multiple locations; i.e., the electrolyzer module includes a plurality of fluid connections to the water supply.

In some embodiments, the system further comprises an oxygen storage system to store oxygen produced by the electrolyzer module. The oxygen storage system is fluidly connected to the electrolyzer module and to the water supply.

In some embodiments, the system further comprises a valve fluidly connected to the electrolyzer module and to the water supply. The valve is operable to increase or decrease the flow of oxygen to the water supply.

In some embodiments, the system further comprises a diffuser fluidly connected to the electrolyzer module. The diffuser is operable to diffuse the oxygen produced by the electrolyzer module into the water supply.

Further provided herein are systems for increasing the oxygen concentration of a water supply. The systems generally comprise an electrolyzer module operable to produce oxygen, a water supply fluidly connected to the electrolyzer module such that the water supply is operable to receive oxygen produced by the electrolyzer module, and a valve fluidly connected to the electrolyzer and the water supply operable to increase or decrease the flow rate of oxygen to the water supply. In some embodiments, the system further comprises a diffuser fluidly connected to the electrolyzer module. The diffuser is operable to diffuse the oxygen produced by the electrolyzer module into the water supply. In still further embodiments, the water supply comprises a municipal water supply, a wastewater supply, or a water supply for aquaculture.

Further provided herein are methods for increasing the oxygen concentration of a water supply. The methods may be accomplished using the systems described herein. Generally, the methods comprise producing oxygen in an electrolyzer module and diffusing a first portion of the oxygen into a water supply, thereby increasing the oxygen concentration of the water supply. In some embodiments, the amount of the first portion of the oxygen diffused into the water supply is varied over time. In other embodiments, the amount of the first portion of oxygen diffused into the water supply is sufficient to disrupt the growth of bacteria. In some additional embodiments, the methods further comprise storing a second portion of the oxygen in an oxygen storage system. In still further embodiments, the methods further comprise increasing or decreasing a flow rate of the first portion of the oxygen. The water in the water supply may be suitable for bathing, exercise, and/or drinking.

### BRIEF DESCRIPTION OF THE DRAWINGS

FIG. 1 shows a block diagram of an embodiment of the system of the present disclosure.

FIG. 2 shows a block diagram of an embodiment of the system of the present disclosure.

FIG. 3 shows a graph of the concentration of oxygen in a water supply over time in an embodiment of the present disclosure.

FIG. 4 shows a graph of the concentration of oxygen in a water supply over the length of a water supply pipeline in an embodiment of the present disclosure.

### DETAILED DESCRIPTION

Described herein are systems and methods for increasing the oxygen concentration in a water supply. The systems of the present disclosure include an electrolyzer stack that is operable to produce oxygen and a water supply that is operable to receive oxygen produced by the electrochemical stack. Rather than releasing the oxygen into the environment, the oxygen may be directly added to the water supply, thereby increasing the oxygen concentration in the water supply. This also improves the safety of operating the electrochemical stack by reducing the amount of ambient oxygen that would otherwise be present around the stack if the oxygen were to be released to the atmosphere. As will be appreciated by those having skill in the art, the presence of an oxygen-rich atmosphere around an electrochemical stack that produces hydrogen gas has a high risk of explosion. Thus, the systems of the present disclosure improve the safety of electrolyzer stack by removing oxygen from the stack and incorporating the oxygen into a water supply.

The system comprises an electrolyzer module. The electrolyzer module comprises an electrolyzer stack operable to convert water into oxygen and hydrogen. Electrolyzer stacks (also referred to as electrochemical stacks) and methods of making and procuring electrolyzer stacks are generally known in the art. In particular, electrolyzer stacks suitable for use in the system of the present disclosure are described in U.S. Application No. 17/101,232 entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety. In some embodiments, the system may comprise a plurality of electrolyzer modules.

The electrolyzer module may comprise a membrane electrolyte such as a proton exchange membrane (PEM). The PEM may comprise any suitable proton exchange (e.g., hydrogen ion transport) polymer membrane, such as Nafion® membrane composed of sulfonated tetrafluoroethylene based fluoropolymer-copolymer having a formula C₇HF₁₃O₅S·C₂F₄.

The electrolyzer stack comprises an inlet operable to receive water from a water source or water reservoir (e.g., municipal water, purified water, etc.). The inlet may therefore be fluidly connected to the water source. The water may be pumped from the water source to the inlet of the electrolyzer stack. Preferably, the water is purified to minimize the amount of impurities introduced into the electrolyzer stack.

The electrolyzer module comprises a first outlet for delivering oxygen to a water supply. The first outlet is therefore fluidly connected to a water supply. The electrolyzer module may generate oxygen at a rate of about 1 kg/hr or greater. For example, the oxygen may be generated at a rate of about 1 kg/hr or greater, about 10 kg/hr or greater, about 25 kg/hr or greater, about 50 kg/hr or greater, or about 100 kg/hr or greater. The oxygen may therefore be delivered to the water supply at a rate of about 1 kg/hr or greater. For example, the oxygen may be delivered to the water supply at a rate of about 1 kg/hr or greater, about 10 kg/hr or greater, about 25 kg/hr or greater, about 50 kg/hr or greater, or about 100 kg/hr or greater.

The electrolyzer module also comprises a second outlet operable to deliver hydrogen to a hydrogen load. As used herein, a “hydrogen load” refers to a system, device, or process that can accept hydrogen and/or that requires hydrogen to function. The second outlet may be fluidly connected to the hydrogen load. The hydrogen load may comprise a dryer, a hydrogen pump, or a hydrogen storage system as described further hereinbelow. The gas flowing from the electrolyzer through the second outlet preferably consists essentially of hydrogen and water. The hydrogen flowing from the electrolyzer module may have a purity of about 90% to about 99%, or more preferably about 95% to about 99% by weight. For example, the purity of the hydrogen gas may be at least about 95%, at least about 96%, at least about 97%, at least about 98%, or at least about 99% on a weight basis. The impurities of the hydrogen gas flowing from the electrolyzer module may include oxygen and water.

The electrolyzer module may receive input energy (i.e., electricity) from an intermittent source such as solar power (including photovoltaic and reflective), wind power, tidal power, wave power, batteries, and other intermittent energy sources known in the art and combinations thereof. Alternatively, or in addition, the electrolyzer stack may receive input energy from a non-intermittent source, such as an electricity grid (e.g., a regional electricity grid, a municipal electricity grid, or a microgrid), natural gas, coal, nuclear, and other non-intermittent sources known in the art and combinations thereof. The electrolyzer stack may therefore be electrically connectable to an intermittent energy input, a non-intermittent source, or a combination thereof.

The system further comprises a water supply. The water supply may be a municipal water supply, a wastewater supply, a water supply for aquaculture (e.g., a shrimp farm), or other water supplies. The water supply may comprise a pipeline that includes flowing water. Alternatively, the water supply may comprise still water (i.e., water that is not flowing) or stagnant water (i.e., water that is not flowing and remains undisturbed for long periods of time). In embodiments where the water is a wastewater supply, the system is operable to increase the oxygen concentration of the water to disrupt bacterial growth and to facilitate oxidation of organic effluents contained in the wastewater supply. A wastewater supply may include, for example, sewage or water wastewater from an industrial facility. In embodiments where the water supply is a water supply for aquaculture, the system is operable to increase the oxygen concentration of the water to provide oxygen for the growth, survival, and health of the aquaculture species.

In some embodiments, the system may comprise a plurality of water supplies. In such embodiments, of the plurality of water supplies may be fluidly connected to one or more electrolyzer modules.

The system may further comprise a valve fluidly connected to with the first outlet of the electrolyzer module and the water supply. The valve may be operable to direct the flow of oxygen to the water supply or to an oxygen load. Thus, the valve is operable to modify the flow rate of the oxygen to the water supply. The valve may be any valve known to those having ordinary skill in the art, such as a globe valve, gate valve, ball valve, butterfly valve, diaphragm valve, plug valve, needle valve, angle valve, pinch valve, slide valve, flush bottom valve, solenoid valve, control valve, flow regulating valve, back pressure regulating valve, y-type valve, piston valve, pressure regulating valve, or a check valve. The system may comprise a plurality of valves, particularly when the system comprises a plurality of electrolyzer modules and/or when the system comprises a plurality of water supplies.

The valve may be electrically connected to a controller. The valve may modify the flow rate of the oxygen to the water supply based on instructions received from the controller. This may be accomplished by a opening or closing the valve in response to a signal received from the controller. The flow rate of oxygen may be modified in according to a predetermined schedule, in response to the oxygen concentration in the water supply reaching a predetermined threshold concentration, or in response to a direct request from a client or customer.

The valve may modify the flow rate of oxygen to the water supply such that the concentration of oxygen in the water supply is from about 1 mg/L to about 20 mg/L or greater. For example, the concentration of oxygen in the water supply may be from about 1 mg/L to about 5 mg/L, about 1 mg/L to about 10 mg/L, about 1 mg/L to about 15 mg/L, about 1 mg/L to about 20 mg/L, about 5 mg/L to about 10 mg/L, about 5 mg/L to about 15 mg/L, about 5 mg/L to about 20 mg/L, about 10 mg/L to about 20 mg/L, or about 15 mg/L to about 20 mg/L. In another example, the concentration of oxygen in the water supply may be about 1 mg/L, about 2 mg/L, about 3 mg/L, about 4 mg/L, about 5 mg/L, about 6 mg/L, about 7 mg/L, about 8 mg/L, about 9 mg/L, about 10 mg/L, about 11 mg/L, about 12 mg/L, about 13 mg/L, about 14 mg/L, about 15 mg/L, about 16 mg/L, about 17 mg/L, about 18 mg/L, about 19 mg/L, or about 20 mg/L. In some embodiments, the concentration of oxygen in the water supply may be greater than about 20 mg/L. In another embodiment, the concentration of oxygen in the water supply may be from at least about 5 mg/L to about 8 mg/L, at least about 5 mg/L to about 10 mg/L, at least about 5 mg/L to about 15 mg/L, at least about 5 mg/L to about 20 mg/L. In another embodiment, the concentration of oxygen in the water supply may be from at least about 6.5 mg/L to about 8 mg/L, at least at least about 6.5 mg/L to about 10 mg/L, at least about 6.5 mg/L to about 15 mg/L, or at least about 6.5 mg/L to about 20 mg/L.

In a preferred embodiment, the concentration of oxygen in the water supply is from about 5 mg/L to about 7 mg/L. It has been shown that concentrations of oxygen dissolved in water in this range may disrupt the growth of bacteria.

The valve may modify the flow rate of oxygen to the water supply such that the saturation of oxygen in the water supply is from about 20% to about 90%.

The valve may be open sufficient to provide a first portion of the oxygen generated by the electrolyzer to the water supply and a second portion of the oxygen to an oxygen load, such as an oxygen storage system.

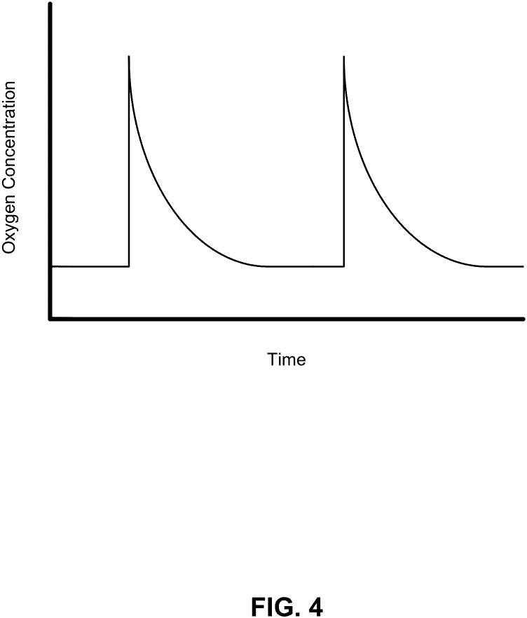

The valve may open and close over a period of time to provide an oxygen concentration gradient that varies over time, as shown in FIG. 4. Without wishing to be bound by theory, the varying concentration of oxygen in the water supply may inhibit or disrupt the growth of bacteria in the water supply. For example, the valve may be entirely open for a period of time, gradually close for a period of time until fully closed, and then open fully one again. This would thus cause the oxygen concentration in the water supply to slowly decrease as the valve closes and then rapidly increase when the valve opens.

The system may further comprise an oxygen load suitable for using the oxygen generated by the electrolyzer module. Oxygen loads may include manufacturing (e.g., steel, plastics, glass, ceramics, textiles, etc.), industrial brazing, welding, or cutting processes, life support systems for medical or other uses (e.g., aircraft, submarine, spacecraft, diving), chemical processes, pharmaceutical processes, oxidation processes (e.g., gold leaching in gold mining), and others known to those having ordinary skill in the art.

The system may further comprise an oxygen sensor operable to measure the concentration of oxygen in the water supply. In some aspects, the system may comprise a plurality of oxygen sensors placed at multiple locations to determine the concentration of oxygen in the water supply over the length of the water supply. This arrangement may be used to determine an oxygen concentration gradient along the length of the water supply. The oxygen sensor may communicate the concentration of oxygen in the water supply to a controller, which may then increase or decrease the flow of oxygen into the water supply if the oxygen concentration is above or below a predetermined value. Preferably, the oxygen sensor has a sensitivity of at least about 1 mg/L, at least about 0.5 mg/L, at least about 0.1 mg/L, or at least about 0.01 mg/L.

The system may increase the oxygen concentration of the water supply by 10% to about 50%.

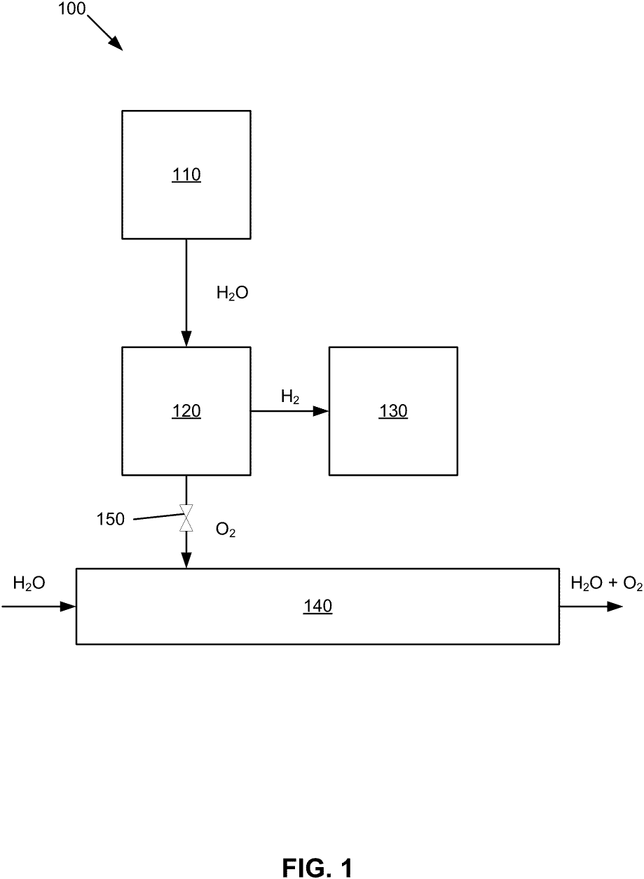

Referring now to FIG. 1, an exemplary system 100 of the present disclosure includes an electrolyzer module 120. The electrolyzer module 120 receives water from a water source 110 and is operable to produce hydrogen and oxygen, and thus is fluidly connected to the water source 110. The electrolyzer module 120 is fluidly connected to a hydrogen load 130 and to a water supply 140. The hydrogen produced in the electrolyzer module 120 is delivered to a hydrogen load 130 and the oxygen is delivered to a water supply 140. The system 100 also includes a valve 150 operable to increase or decrease the flow rate of the oxygen.

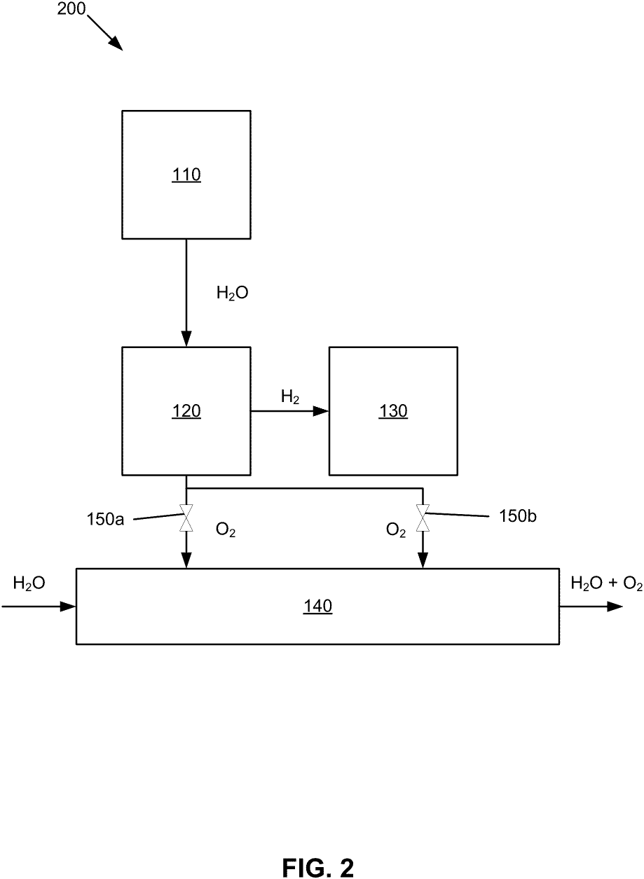

Referring now to FIG. 2, the system 200 may introduce oxygen to the water supply 140 at more than one location. Thus, the first outlet of the electrolyzer module 120 may be fluidly connected to the water supply at more than one location. In particular, if the water supply 140 comprises a pipeline, this arrangement may be useful to achieve a more uniform oxygen concentration in the pipeline. In such embodiments, the system may include a plurality of valves (150a, 150b) to control the flow of oxygen into the water supply 140 at each location.

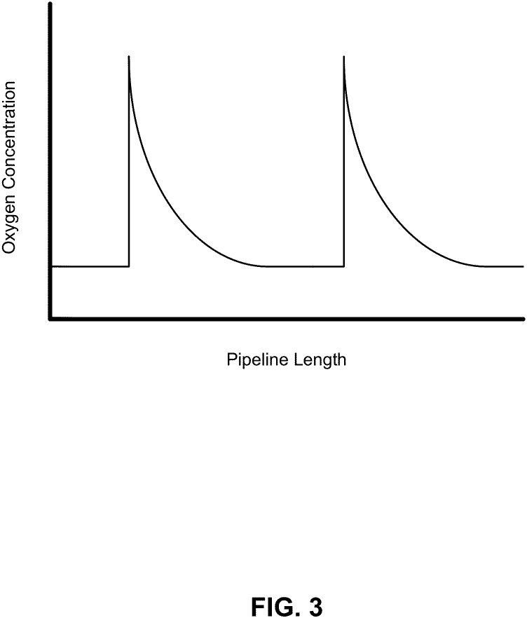

The arrangement shown in FIG. 2 may also be useful to disrupt the growth of bacteria in the water supply by creating an oxygen concentration gradient along the length of the pipeline, as shown in FIG. 3. Without wishing to be bound by any particular theory, increasing and decreasing the oxygen concentration along the length of the water supply may disrupt the growth of bacteria. At the first location where oxygen is introduced to the water supply, the oxygen concentration of the water supply may rapidly increase and then gradually decrease as the water moves further down the pipeline. The oxygen concentration may decrease due to consumption or oxidation reactions taking place along the length of the pipeline. At the second location where oxygen is introduced to the water supply, this oxygen concentration gradient is repeated. Those having ordinary skill in the art will appreciate that the oxygen concentration gradient may be modified by increasing or decreasing the flow rate of the oxygen into the water supply and increasing or decreasing the distance between the two locations where the oxygen is introduced to the water supply.

The system may disrupt or inhibit the growth of waterborne bacteria, such as Escherichia coli, Pseudomonas, Legionella (including Legionella pneumophila), Shigella (including Shigella flexneri, Shigella dysenteriae, Shigella boydii, Shigella sonnei), Vibrio (including Vibrio cholerae, Vibrio fluvialis, Vibrio mimicus, Vibrio furnissii, Vibrio vulnificus, and Vibrio parahaemolyticus), Salmonella (including Salmonella enterica), Burkholderia (including Burkholderia cepacian, Burkholderia pseudomallei, Burkholderia mallei, and Burkholderia gladioli), Campylobacter (including Campylobacter jejuni, Campylobacter coli, Campylobacter Iari, and Campylobacter fetus), and Mycobacterium (including Mycoacterium avium and Mycobacterium intracellulare).

The system may further comprise an oxygen storage system. The electrolyzer module may be fluidly connectable to the oxygen storage system. The water supply may also be fluidly connectable to the oxygen storage system. The oxygen storage system may be operable to provide an uninterrupted flow of oxygen to the water supply when the electrolyzer module is not generating oxygen (e.g., during maintenance or shut down of the electrolyzer module). In embodiments where the system includes the valve, the valve may be operable to redirect all or a portion of the flow of oxygen to or from the oxygen storage system; i.e., the valve may be operable to distribute the flow of oxygen between the oxygen storage system and the water supply.

The system may further comprise a diffuser. The diffuser is operable to disperse the oxygen in the water supply such that the oxygen is dissolved in the water. Devices for diffusing oxygen in water and methods of making and procuring the same are generally known in the art. The diffuser may comprise a microbubble diffuser, an atomizer, a sparser, or other devices suitable for diffusing oxygen in water. The system may comprise a plurality of diffusers, particularly when the system comprises a plurality of electrolyzer modules and/or a plurality of water supplies.

The electrolyzer module may further comprise a dryer. The dryer may be, for example, a pressure swing adsorption (PSA) system, a temperature swing adsorption (TSA) system, a hybrid PSA-TSA system, or a membrane purifier. The dryer may comprise an inlet portion and an outlet portion. The dryer may include one or more beds of a water-adsorbent material, such as activated carbon, silica, zeolite or alumina. The dryer may include a membrane such as a PEM electrolyte. The inlet portion is operable to receive hydrogen gas from the electrolyzer stack. The inlet portion may therefore be fluidly connected to the second outlet of the electrolyzer module. The hydrogen gas may have a purity of about 95% to about 98%, wherein the major impurity is water. The outlet portion is operable to provide dry hydrogen to a hydrogen load such as a hydrogen pump, a hydrogen fuel cell, and/or a hydrogen storage system. The outlet portion may therefore be fluidly connected to the hydrogen pump, a hydrogen fuel cell, and/or the hydrogen storage system. The dryer may also comprise a second outlet comprising low pressure hydrogen, e.g., from about 1 to about 2 bar, or less than about 1 bar.

The dryer may further comprise a purge stream. The purge stream is operable to remove excess water vapor and other gases, including oxygen, from the hydrogen produced in the electrolyzer module. The purge stream may comprise hydrogen having a concentration from about 5% to about 25%, or more preferably less than 5%. The balance of the purge stream may comprise water and oxygen. The purge stream may be fluidly connected to the water supply or to the atmosphere.

The system may further comprise a proton conducting hydrogen pump. The proton conducting hydrogen pump (also referred to herein as a “hydrogen pump”) may be, for example, an electrochemical pump. As used in this context, an electrochemical pump shall be understood to include a proton exchange membrane (i.e., a PEM electrolyte) disposed between an anode and a cathode. The proton exchange membrane may be any proton exchange membrane discussed herein. The hydrogen pump may generate protons moveable from the anode through the proton exchange membrane to the cathode form pressurized hydrogen. Thus, the hydrogen pump may be operable to provide pressurized hydrogen produced by the electrolyzer module to a hydrogen load. The hydrogen pump may be fluidly connected to a dryer, to the hydrogen generator, and/or to a hydrogen generation system.

In particular, hydrogen pumps suitable for use in the system of the present disclosure are described in U.S. Application No. 17/101,232 entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety.

The hydrogen pump may be operable to improve the purity of the hydrogen. For example, the hydrogen flowing from the hydrogen pump may have a purity of about 98% to about 99.999%, such as from about 98% to about 99%, about 98% to about 99.9%, about 98% to about 99.99%, about 98% to about 99.999%, about 99% to about 99.999%, about 99.9% to about 99.999%, or about 99.99% to about99.999%. The major impurities of the hydrogen flowing from the hydrogen pump may include oxygen and water.

The hydrogen load may further comprise a hydrogen storage system. Systems and methods for storing hydrogen are generally well-known in the art and include, for example, storage tanks and vessels. The electrolyzer module may be fluidly connectable to the hydrogen storage system. The electrolyzer module may be fluidly connected to the hydrogen storage system. The hydrogen storage system may comprise pressurized hydrogen. The pressurized hydrogen may be stored at a pressure from about 10 bar to about 800 bar; for example, about 10 bar, about 50 bar, about 100 bar, about 150 bar, about 200 bar, about 250 bar, about 300 bar, about 350 bar, 400 bar, 450 bar, 500 bar, 550 bar, 600 bar, 650 bar, about 700 bar, about 750 bar, or about 800 bar. The pressurized hydrogen may be stored at a pressure from about 10 bar to about 50 bar, about 10 bar to about 100 bar, about 10 bar to about 200 bar, about 10 bar to about 300 bar, about 10 bar to about 400 bar, about 10 bar to about 500 bar, about 10 bar to about 600 bar, about 10 bar to about 700 bar, about 10 bar to about 800 bar, about 100 bar to about 800 bar, about 200 bar to about 800 bar, about 300 bar to about 800 bar, about 400 bar to about 800 bar, about 500 bar to about 800 bar, about 600 bar to about 800 bar, about 700 bar to about 800 bar, about 300 bar to about 700 bar, or about 300 bar to about 600 bar. In some examples, the hydrogen may be stored at a pressure of about 350 bar, about 550 bar, or about 700 bar. One or more hydrogen pumps may be used to pressurize the hydrogen. Alternatively, other devices and systems to increase the pressure of hydrogen may be used, such as a compressor.

The electrolyzer module may further comprise power electronics. The power electronics may be formed or provided in a single assembly that connects input energy, the electrolyzer stack, and/or additional energy outputs or energy loads. The power electronics may be operable to connect to DC energy inputs, AC energy inputs, and combinations thereof. The power electronics may further be operable to connect to DC energy loads, AC energy loads, and combinations thereof. The power electronics may comprise a GaN inverter board, an integrated power board, control cards, a display board, and/or a DAB converter, one or more transformers, one or more rectifiers, etc.

The system may further comprise an energy storage mechanism or a plurality of energy storage mechanisms. The energy storage mechanism may comprise any mechanism or apparatus operable to store energy such as electricity, thermal energy, etc. For example, the energy storage mechanism may include batteries (e.g., lead-acid batteries, lithium ion batteries, lithium iron batteries, etc.), ice, water, flywheels, compressed air, pumped hydroelectric, or other energy storage mechanisms known in the art and combinations thereof.

The system may further comprise a controller. The controller may be electrically connected to one or more of the system components described hereinabove. The controller is operable to adjust various parameters of the system and the components of the system based on various inputs received, such as temperature, flow rate, pressure, current, etc. The controller may also be operable to turn one or more system components off and on.

The oxygenated water provided by the systems of the present disclosure may be suitable for a variety of different applications. In some examples, the water in the water supply may be suitable for bathing, exercise (e.g., swimming), and/or for drinking.

Further provided herein is a method for increasing the oxygen concentration of a water supply. The method may be accomplished using any of the systems described hereinabove. The method includes producing oxygen in an electrolyzer module and adding a first portion of the oxygen to the water supply. Preferably, the step of adding the first portion of the oxygen to the water supply comprises diffusing the first portion of the oxygen into the water supply. This may be accomplished by using a diffuser as described hereinabove. The amount of oxygen added to the water supply may be varied over time; i.e., the amount of the first portion of the oxygen may be varied over time.

The methods may further comprise producing hydrogen in the electrolyzer, as described herein. The hydrogen may be stored in a hydrogen storage system or provided to a hydrogen load as described hereinabove.

### DEFINITIONS

As used herein, a “fluid” connection is a connection that allows for or facilitates the transfer of fluids including liquids and gases. Non-limiting examples of fluid connections include pipes, manifolds, ducts, valves, hoses, couplings, tubes, etc.

As used herein, an “electrical” connection is a connection that allows for or facilitates the transfer of electricity. Non-limiting examples of electrical connections include wires, cables, power lines, breakers, transformers, converters, rectifiers, switches, etc.

As used herein, an “operable” connection includes any connection that allows for or facilitates the operation of a system unit or process. An operable connection may include an electrical connection and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for increasing the oxygen concentration of a water supply comprising:
an electrolyzer module operable to produce oxygen; and
a water supply fluidly connected to the electrolyzer module such that the water supply is operable to receive oxygen produced by the electrolyzer module.

2. The system of claim 1, further comprising an oxygen storage system fluidly connected to the electrolyzer module and to the water supply.

3. The system of claim 1, further comprising a valve fluidly connected to the electrolyzer module and the water supply.

4. The system of claim 3, wherein the valve is operable to increase or decrease a flow rate of the oxygen to the water supply.

5. The system of claim 1, wherein the oxygen concentration of the water supply is from about 1 mg/L to about 20 mg/L.

6. The system of claim 1, further comprising a diffuser fluidly connected to the electrolyzer module, wherein the diffuser is operable to diffuse the oxygen produced by the electrolyzer module into the water supply.

7. The system of claim 1, wherein the water supply comprises a pipeline.

8. The system of claim 1, wherein the water supply comprises a municipal water supply, a wastewater supply, or a water supply for aquaculture.

9. The system of claim 1, wherein the electrolyzer module is fluidly connected to the water supply at multiple locations.

10. A system for increasing the oxygen concentration of a water supply comprising:
an electrolyzer module operable to produce oxygen;
a water supply fluidly connected to the electrolyzer module such that the water supply is operable to receive oxygen produced by the electrolyzer module; and
a valve fluidly connected to the electrolyzer and the water supply operable to increase or decrease the flow rate of oxygen to the water supply.

11. The system of claim 10, further comprising a diffuser fluidly connected to the electrolyzer module and the water supply, wherein the diffuser is operable to diffuse the oxygen produced by the electrolyzer module into the water supply.

12. The system of claim 10, wherein the water supply comprises a municipal water supply, a wastewater supply, or a water supply for aquaculture.

13. A method for increasing the oxygen content of a water supply, the method comprising:
producing oxygen in an electrolyzer module; and
diffusing a first portion of the oxygen into a water supply.

14. The method of claim 11, wherein the amount of the first portion of the oxygen diffused into the water supply is varied over time.

15. The method of claim 11, wherein the amount of the first portion of oxygen diffused into the water supply is sufficient to disrupt the growth of bacteria.

16. The method of claim 11, further comprising storing a second portion of the oxygen in an oxygen storage system.

17. The method of claim 11, further comprising increasing or decreasing a flow rate of the first portion of the oxygen.

18. The method of claim 11, wherein the water in the water supply is suitable for bathing.

19. The method of claim 11, wherein the water in the water supply is suitable for exercise.

20. The method of claim 11, wherein the water in the water supply is suitable for drinking.
